(19) United States
(12) Patent Application Publication
(10) Pub. No.: US 2023/0068556 A1
(43) Pub. Date: Mar. 2, 2023

(54) HARVESTING DEVICE, HARVESTING METHOD, AND PROGRAM

(71) Applicant: Panasonic Intellectual Property Management Co., Ltd., Osaka (JP)

(72) Inventors: RYOU TOSHIMA, Nara (JP); HIDEKAZU ARAKI, Osaka (JP); SEIJI NISHITANI, Kyoto (JP)

(21) Appl. No.: 17/819,543

(22) Filed: Aug. 12, 2022

(30) Foreign Application Priority Data
Aug. 27, 2021 (JP) 2021-138977

(51) Int. Cl. A01D 46/30; G05D 1/02; G06V 20/58

(52) U.S. Cl. CPC A01D 46/30; G05D 1/0212; G06V 20/58; G05D 2201/0201; B25J 11/0045

(57) ABSTRACT

A harvesting device includes: a harvesting unit that harvests an object to be harvested; a harvesting unit-moving unit that moves the harvesting unit to an appropriate position for harvesting the object to be harvested; an imaging unit that captures an image; and a controller, wherein the controller performs a first step of determining, based on the image, whether or not interference between the harvesting unit and an obstacle occurs when the harvesting unit is positioned at the appropriate position, a second step of determining, based on the image, whether or not interference between the harvesting unit-moving unit and the obstacle occurs when the harvesting unit is positioned at the appropriate position, when it is determined in the first step that the interference does not occur, and a third step of causing the harvesting unit to harvest the object to be harvested when it is determined in the second step that the interference does not occur.

### BACKGROUND

### 1. Technical Field

The present disclosure relates to a harvesting device, a harvesting method, and a program for harvesting an object to be harvested such as a fruit.

### 2. Description of the Related Art

Automation of crop harvesting work is desired.

As an example of a device for automatically harvesting an object to be harvested, a harvesting device described in PTL 1 is known. The harvesting device disclosed in PTL 1 includes a vacuum pad that causes fruit as the object to be harvested to stick thereon by a vacuum suction device, and a motor that rotates and vibrates the vacuum pad. The harvesting device disclosed in PTL 1 harvests pieces of fruit growing on branches by rotating and vibrating the vacuum pad with the pieces of fruit stuck thereon.

Since the harvesting device disclosed in PTL 1 sucks part of a surface of the fruit by vacuum suction, the suction may leave a mark or the like on the fruit and thus damage the fruit.

PTL 2 discloses an example of a harvesting device that suppresses damage to the object to be harvested. In addition, PTL 3 discloses a harvesting method that uses a flexible harvesting arm to avoid obstacles such as a main stem and clusters during harvesting.

### CITATIONS LIST

### Patent Literature

PTL 1: Unexamined Japanese Patent Publication S63-141517
PTL 2: Unexamined Japanese Patent Publication No. 2017-51103
PTL 3: Unexamined Japanese Patent Publication No. H8-238014

### SUMMARY

A harvesting device according to one aspect of the present disclosure includes: a harvesting unit that harvests an object to be harvested; a harvesting unit-moving unit that moves the harvesting unit to an appropriate position for harvesting the object to be harvested; an imaging unit that captures an image; and a controller, wherein the controller performs a first step of determining, based on the image, whether or not interference between the harvesting unit and the obstacle occurs when the harvesting unit is positioned at the appropriate position, a second step of determining, based on the image, whether or not interference between the harvesting unit-moving unit and the obstacle occurs when the harvesting unit is positioned at the appropriate position, when it is determined in the first step that the interference does not occur, and a third step of causing the harvesting unit to harvest the object to be harvested when it is determined in the second step that the interference does not occur.

A harvesting method according to an aspect of the present disclosure is performed by a computer that controls a harvesting device, the method including: a first step of determining, based on a captured image, whether or not interference between a harvesting unit that harvests an object to be harvested and an obstacle occurs when the harvesting unit is positioned at an appropriate position for harvesting the object to be harvested; a second step of determining, based on the captured image, whether or not interference between a harvesting unit-moving unit that moves the harvesting unit to the appropriate position and the obstacle occurs when the harvesting unit is positioned at the appropriate position, when it is determined in the first step that the interference does not occur; and a third step of causing the harvesting unit to harvest the object to be harvested when it is determined in the second step that the interference does not occur.

A recording medium recording a program according to one aspect of the present disclosure is executed by a computer that controls a harvesting device, the program causing the computer to perform: a first procedure of determining, based on a captured image, whether or not interference between a harvesting unit that harvests an object to be harvested and an obstacle occurs when the harvesting unit is positioned at an appropriate position for harvesting the object to be harvested; a second procedure of determining, based on the captured image, whether or not interference between a harvesting unit-moving unit that moves the harvesting unit to the appropriate position and the obstacle occurs when the harvesting unit is positioned at the appropriate position, when it is determined in the first procedure that the interference does not occur; and a third procedure of causing the harvesting unit to harvest the object to be harvested when it is determined in the second procedure that the interference does not occur.

### BRIEF DESCRIPTION OF THE DRAWINGS

FIG. 1 is a diagram illustrating a structure of a cluster of cherry tomatoes as examples of objects to be harvested;

FIG. 2 is a diagram illustrating a structure of a harvesting device according to an exemplary embodiment of the present disclosure;

FIG. 3 is a top schematic view of a work arm and an end effector;

FIG. 4 is a flowchart illustrating example operation of the harvesting device;

FIG. 5A is a diagram illustrating a method of creating an obstacle map;

FIG. 5B is a diagram illustrating the method of creating the obstacle map;

FIG. 6 is a diagram illustrating a concept of a method of determining a harvesting direction;

FIG. 7A is a diagram illustrating the concept of the method of determining the harvesting direction;

FIG. 7B is a diagram illustrating the concept of the method of determining the harvesting direction;

FIG. 8A is a diagram illustrating an end effector map including an end effector region that indicates a position of the end effector;

FIG. 8B is a diagram illustrating a first interference map obtained by superimposing the obstacle map and the end effector map;

FIG. 9 is a diagram illustrating a harvesting pose map;

FIG. 10 is a diagram illustrating an interference map;

FIG. 11 is an enlarged perspective view of the end effector;

FIG. 12A is a diagram illustrating operation of the end effector during harvesting;

FIG. 12B is a diagram illustrating the operation of the end effector during harvesting; and

FIG. 12C is a diagram illustrating the operation of the end effector during harvesting.

### DETAILED DESCRIPTIONS

There is a demand for a harvesting method capable of enhancing stability of harvest by appropriately determining whether or not harvest is possible according to whether there is an obstacle or not.

An object of the present disclosure is to provide a harvesting device, a harvesting method, and a program capable of enhancing the stability of harvest.

In the following, a harvesting device according to an exemplary embodiment of the present disclosure will be described in detail with reference to the drawings.

<Description of Object to be Harvested>

First, an object to be harvested by the harvesting device will be described. In the following description, cherry tomatoes that grow in clusters each including a dense group of a plurality of cherry tomatoes are used as an example of the object to be harvested.

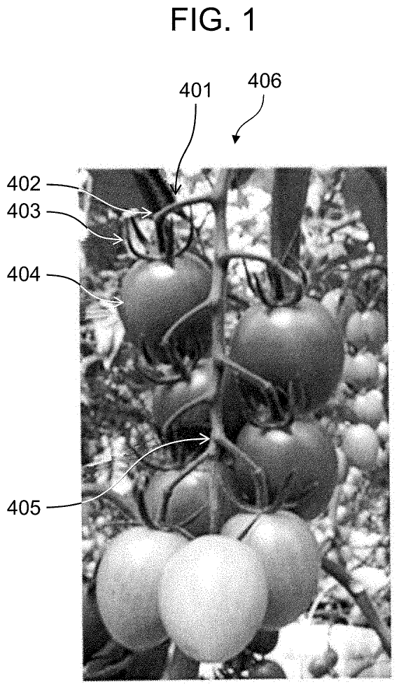

FIG. 1 is a diagram showing a structure of a cluster of cherry tomatoes. As shown in FIG. 1, one cluster 406 is formed around a stem called peduncle 405. Pedicels 401 and calices 403 extend from peduncle 405, and fruit 404 is formed at tips.

There is a part called abscission layer 402 in the middle of pedicel 401. When a force is applied to pedicle 401, pedicle 401 is torn at abscission layer 402.

An object to be harvested by a harvesting device according to one aspect of the present disclosure is a fruit that has an abscission layer as described above. Therefore, an object to be harvested by a harvesting device according to one aspect of the present disclosure is not limited to a cherry tomato, and it can be any other fruit that has an abscission layer. In addition, the object to be harvested by the harvesting device of the present disclosure is not limited to a fruit that grows in clusters. It may instead be a fruit that grows individually.

<Structure of Harvesting Device 1>

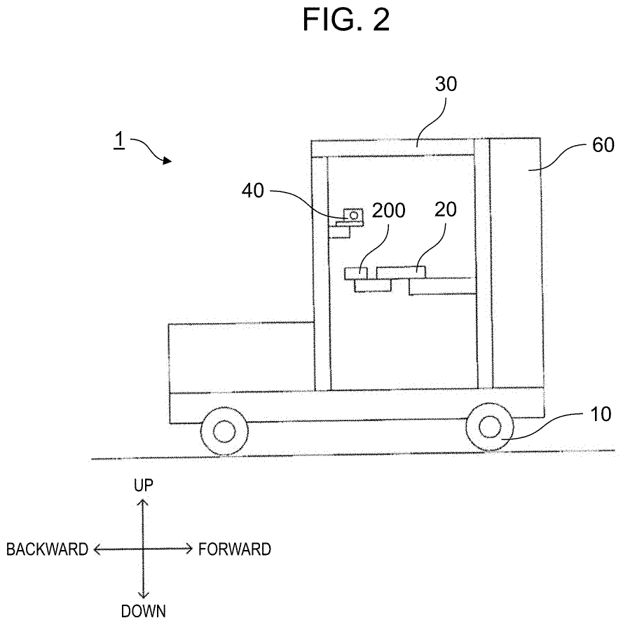

FIG. 2 is a diagram illustrating a structure of harvesting device 1 according to the exemplary embodiment of the present disclosure. Harvesting device 1 includes main body moving unit 10, work arm 20, end effector 200, main body 30, imaging device 40, and controller 60. Note that FIG. 2 is a side view of harvesting device 1, and a vertical direction in the following description corresponds to a vertical direction of harvesting device 1 illustrated in FIG. 2.

Main body moving unit 10 is a structure for moving entire main body 30 of harvesting device 1, such as wheels or continuous tracks. Since main body 30 is provided with the other components of harvesting device 1, that is, work arm 20, end effector 200, imaging device 40, and controller 60, movement of main body 30 means movement of entire harvesting device 1.

In the present exemplary embodiment, description will be given of a case where main body moving unit 10 can move main body 30 only in one predetermined direction and the opposite direction, such as when main body 30 is moved on rails laid between ridges. However, the present disclosure is not limited to this, and main body moving unit 10 may be capable of moving main body 30 in any direction. In the following description, a direction in which main body moving unit 10 moves main body 30 is referred to as a moving direction. Since the moving direction is used when two-dimensional map 500 described later is created, in the case where main body 30 can move in any direction, for example, the moving direction of main body moving unit 10 used to create two-dimensional map 500 may be defined by referring to a direction in which the object to be harvested is located.

In the present exemplary embodiment, main body moving unit 10 can move main body 30 along a forward-backward direction. Note that the forward-backward direction of harvesting device 1 is a direction in which harvesting device 1 moves when the object to be harvested is on the left or right as viewed from harvesting device 1. A right direction in FIG. 2 corresponds to the forward direction of harvesting device 1, and a left direction in FIG. 2 corresponds to the backward direction of harvesting device 1.

End effector 200 is a part that harvests the object to be harvested without damaging it. End effector 200 is an example of a harvesting unit of the present disclosure. A structure and operation of end effector 200 will be described in detail later.

Work arm 20 is a part for moving end effector 200 to a position where it can harvest the object to be harvested easily. Work arm 20 is an example of a harvesting unit-moving unit of the present disclosure. One end of work arm 20 is attached to main body 30, and the other end is attached to end effector 200. Work arm 20 can cause end effector 200 to harvest the object to be harvested by moving end effector 200 to a position suitable for harvesting the object to be harvested at a position far from harvesting device 1.

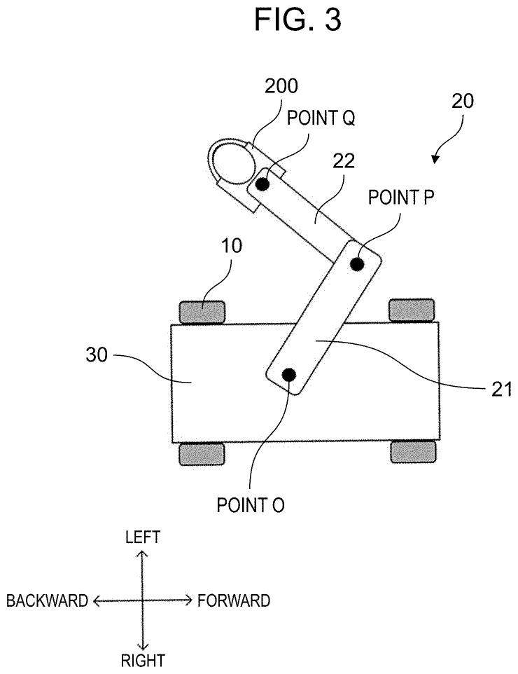

FIG. 3 is a top schematic view of work arm 20 and end effector 200. FIG. 3 illustrates work arm 20 having a three-axis selective compliance assembly arm as an example of the work arm. Work arm 20 includes first link 21 and second link 22. End effector 200 is attached to leading end part of second link 22. End effector 200 is rotatable about the leading end part (point Q in FIG. 3) of second link 22 as a rotation axis.

An example illustrated in FIG. 3 shows a state where work arm 20 and end effector 200 extend in the left direction of harvesting device 1. It is assumed that work arm 20 and end effector 200 extend in the left direction of harvesting device 1 in the following description of the present exemplary embodiment as well. However, the present disclosure is not limited to this, and work arm 20 and end effector 200 may extend in any direction from main body 30.

Main body 30 is a main body of harvesting device 1, and includes main body moving unit 10, work arm 20, imaging device 40, and controller 60.

Imaging device 40 is a camera device that generates an image by photographing at least one of the object to be harvested, an obstacle, end effector 200, and work arm 20. In particular, imaging device 40 is a camera capable of acquiring red, green, and blue (RGB) color images, infrared (IR) images, and distance data.

Controller 60 is a computer that controls each component of harvesting device 1. For example, controller 60 is a computer including a central processing unit (CPU), a read only memory (ROM), and a random access memory (RAM). Controller 60 reads out a program stored in the ROM, loads the program into the RAM, and controls each component of harvesting device 1 according to the loaded program. The RAM forms a work area in which various programs to be executed by the CPU and data related to the programs are temporarily stored. The ROM is composed of a nonvolatile memory and the like, and stores various programs and various data that are to be used for control. Note that the computer that controls harvesting device 1 may be provided outside harvesting device 1 and remotely operate harvesting device 1 via a communication network or the like.

More specifically, controller 60 analyzes the captured image generated by imaging device 40, and controls the operation of main body moving unit 10, work arm 20, and end effector 200 based analysis results.

<Example Operation of Harvesting Device 1>

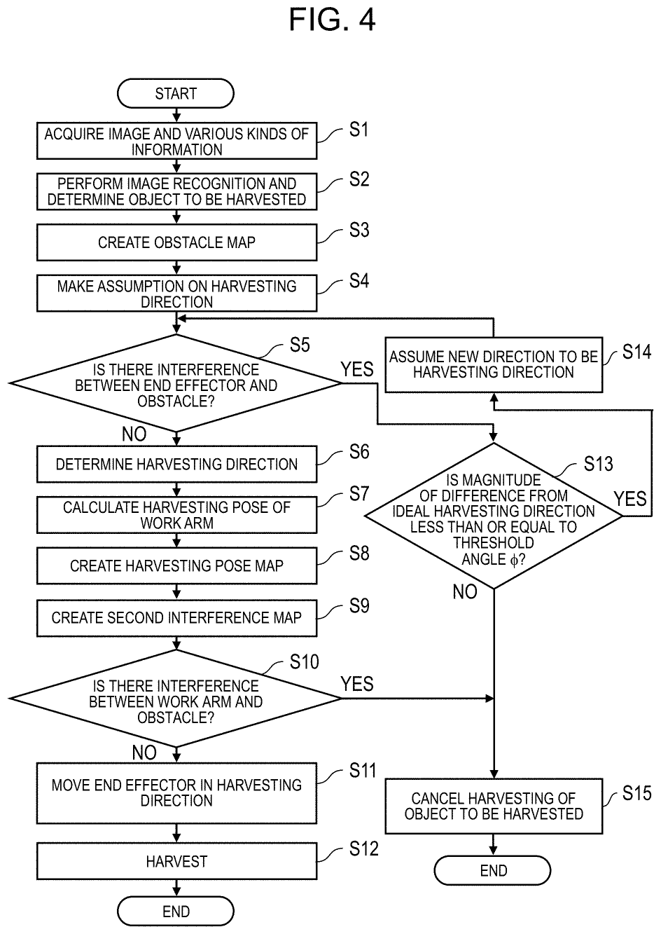

Next, example operation performed by harvesting device 1 when harvesting the object to be harvested will be described with reference to FIG. 4. FIG. 4 is a flowchart illustrating the example operation of harvesting device 1. Note that the example operation of harvesting device 1 illustrated in FIG. 4 will be described assuming that one of a plurality of pieces of fruit is determined to be the object to be harvested, and harvesting device 1 is at a position that is almost directly in front of the object to be harvested.

First, in step S1, controller 60 causes imaging device 40 to photograph a target piece of fruit, a cluster including the piece of fruit, a stem, an entire plant, and the like, and acquires an image, color information and distance information of each subject, and the like.

Next, in step S2, controller 60 obtains positional information of the object to be harvested indicating a position of the object to be harvested, and obstacle positional information indicating a position of an obstacle based on the image and the distance information generated by imaging device 40. The obstacle is an object that can be an obstacle when the object to be harvested is harvested, and, in the present exemplary embodiment, it is a main stem or a leaf.

A known method can be adopted as a method of recognizing the object to be harvested or the obstacle in the image. As the method of recognizing a fruit as the object to be harvested based on the image, for example, a technique described in JP 2018-206015 A can be applied. As the method of recognizing the main stem as the obstacle based on the image, for example, a technique described in JP 2020-000170 A can be applied.

Next, in step S3, controller 60 creates an obstacle map based on the positional information of the object to be harvested and the obstacle positional information. In the following, a method of creating the obstacle map will be described in detail.

[Method of Creating Obstacle Map]

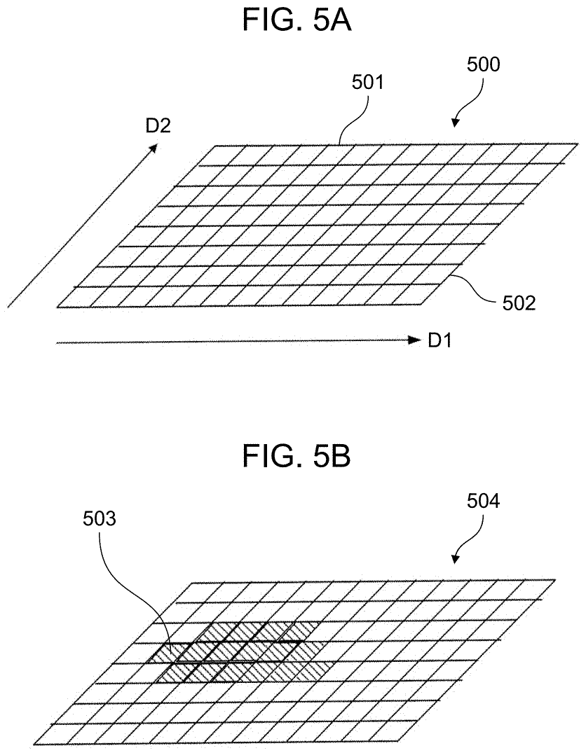

FIGS. 5A and 5B are diagrams illustrating the method of creating the obstacle map. A method of creating a two-dimensional obstacle map will be described in detail below.

First, controller 60 creates two-dimensional grid map 500 as illustrated in FIG. 5A based on the positional information of the object to be harvested. In an example illustrated in FIG. 5A, two-dimensional map 500 is a map having two axes (first axis 501, second axis 502) along two directions (first direction D1, second direction D2). Two-dimensional map 500 is created so as to include the positional information of the object to be harvested.

First direction D1 corresponds to a direction in which harvesting device 1 can move (the forward-backward direction), and first axis 501 is an axis extending along first direction D1. Second direction D2 corresponds to a direction of the object to be harvested as viewed from harvesting device 1, and second axis 502 is an axis perpendicular to first direction D1. That is, FIG. 5A illustrates planar two-dimensional map 500 as viewed from diagonally above. Note that a distance between axes in a same direction, that is, a cell size can be set to an appropriate size such as 1 mm, for example.

Next, for each cell of two-dimensional map 500, controller 60 gives a value of “1” when an obstacle is found in the cell and a value of “0” when an obstacle is found in the cell based on the obstacle positional information. As a result, as illustrated in FIG. 5B, obstacle map 504 is created. As with FIG. 5A, FIG. 5B illustrates planar two-dimensional map 500 as viewed from diagonally above. In FIG. 5B, the cells where an obstacle is found, that is, cells having a value of “1” are hatched. Since an obstacle generally has some size, cells where an obstacle is found are adjacent to each other. In the example illustrated in FIG. 5B, an obstacle map is illustrated that includes obstacle region 503 as a group of a plurality of cells indicating the positions where obstacles are found.

Note that, although a method of creating a two-dimensional obstacle map is described above, in a case where a three-dimensional obstacle map is required, a three-dimensional obstacle map can be created by stacking two-dimensional obstacle maps created using the above method along a third axis parallel to a height direction.

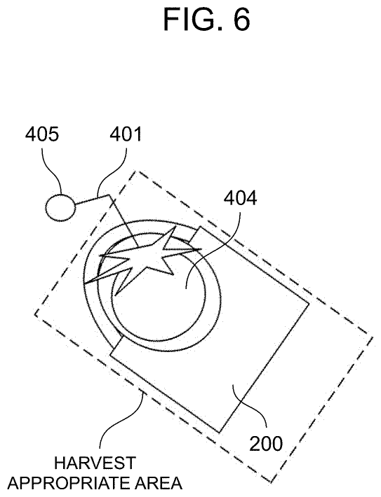

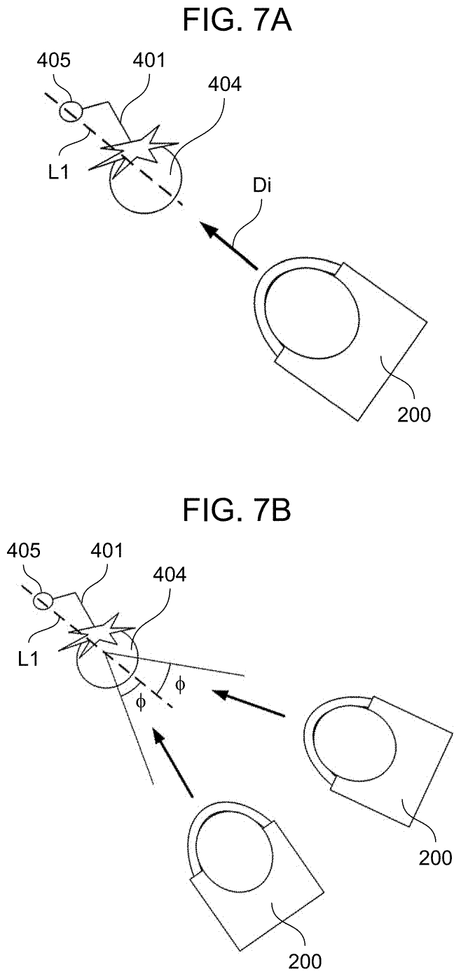

Next, in steps S4 to S6 and steps S13 to S14, controller 60 determines a harvesting direction that is a direction in which end effector 200 is moved when the object to be harvested is harvested. A method of determining the harvesting direction will be described with reference to FIGS. 6, 7A, and 7B.

[Method of Determining Harvesting Direction]

FIGS. 6, 7A, and 7B are diagrams illustrating a concept of the method of determining the harvesting direction. FIGS. 6, 7A, and 7B schematically illustrate a positional relationship when fruit 404 as the object to be harvested and end effector 200 are viewed from above.

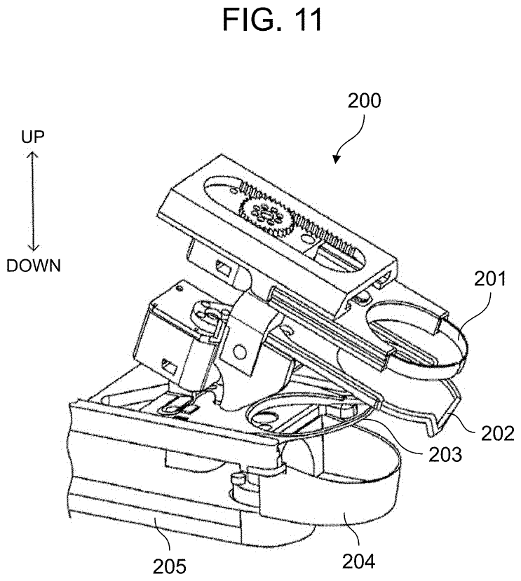

When fruit 404 is harvested using end effector 200, end effector 200 needs to be moved to an appropriate position for harvesting. As illustrated in FIG. 6, the appropriate position for harvesting is a position where a ring member (harvesting ring 202 in FIG. 11 described later) of end effector 200 is placed around fruit 404. By moving end effector 200 to such an appropriate position, end effector 200 can easily tear fruit 404 apart at abscission layer 402 (see FIG. 1).

Here, when end effector 200 is moved to the appropriate position illustrated in FIG. 6, in order to minimize damage to the object to be harvested, it is ideal to move end effector 200 in a direction from a fruit 404 side toward a peduncle 405 side along straight line L1 passing through centers of peduncle 405 and fruit 404 as illustrated in FIG. 7A. In the following description, the moving direction of end effector 200 illustrated in FIG. 7A will be referred to as ideal harvesting direction Di. Ideal harvesting direction Di is an example of a third direction of the present disclosure.

However, in actual harvesting work, in a case where there is an obstacle such as a stem or a leaf near fruit 404, it is not always possible to move end effector 200 along ideal harvesting direction Di illustrated in FIG. 7A.

Therefore, in step S4, controller 60 assumes the harvesting direction of end effector 200 to be the ideal harvesting direction. Then, in step S5, controller 60 simulates whether end effector 200 interferes with the obstacle when the assumed harvesting direction and the position (appropriate position) of end effector 200 that allows it to harvest the object to be harvested are used. Specifically, whether end effector 200 interferes with an obstacle if it is positioned at the appropriate position is determined by simulating whether an obstacle is in an end effector region shown in FIG. 6 and indicated by a broken line. The end effector region is a region for when end effector 200 is at the appropriate position. It has a certain size, and a center thereof is the object to be harvested. The size of the region and a position of the center thereof can be set as appropriate.

When it is determined that end effector 200 and the obstacle do not interfere with each other from the simulation (step S5: NO), in step S6, controller 60 determines the assumed harvesting direction to be an actual harvesting direction.

On the other hand, when it is determined that end effector 200 and the obstacle interfere with each other (step S5: YES), in steps S13 and S14, controller 60 slightly shifts the harvesting direction from the ideal harvesting direction, and again assumes that this shifted harvesting direction is the harvesting direction. Specifically, in step S13, controller 60 determines whether or not a magnitude of a difference between the currently assumed harvesting direction and the ideal harvesting direction is less than or equal to threshold angle φ, and when it is determined that the magnitude of the difference is less than or equal to threshold angle φ (step S13: YES), processing proceeds to step S14. In step S14, controller 60 slightly shifts the currently assumed harvesting direction, assumes the shifted harvesting direction to be a new harvesting direction, and returns the processing to step S5. Then, in step S5, controller 60 again simulates whether or not end effector 200 and the obstacle interfere with each other if end effector 200 is moved in the shifted harvesting direction. By repeating procedures of steps S4 and S5 as described above, controller 60 can determine the harvesting direction of end effector 200 that prevents end effector 200 from interfering with the obstacle.

Note that, the greater the magnitude of the difference of the harvesting direction from the ideal harvesting direction, the greater a possibility that harvesting by end effector 200 fails. Therefore, in the present exemplary embodiment, threshold angle φ is set so that the magnitude of the difference from the ideal harvesting direction is less than or equal to a certain magnitude. Specifically, as shown in FIG. 7B, the harvesting direction is determined so that an angle formed by the harvesting direction and the ideal harvesting direction (the direction along straight line L1 passing through the centers of peduncle 405 and fruit 404) is less than or equal to threshold angle φ. Threshold angle φ is set to, for example, 30°. In addition, in a case where the harvesting direction is shifted in step S14, the harvesting direction is set to be shifted by, for example, 10° at a time. Threshold angle φ and a magnitude of an angle the harvesting direction is shifted by at a time can be set as appropriate.

As described above, in a case where end effector 200 and the obstacle interfere with each other if end effector 200 is moved in the ideal harvesting direction, as illustrated in FIG. 7B, the moving direction of end effector 200, that is, the harvesting direction is set to a direction shifted from the ideal harvesting direction by a threshold angle or less. Therefore, obstacles can be avoided while end effector 200 is being moved to the appropriate position. This enables stable harvesting. The shifted harvesting direction that makes it possible to prevent an interference with the obstacle is an example of a fourth direction of the present disclosure.

Note that, in a case where a harvesting direction that prevents the interference between end effector 200 and the obstacle is not found in a range of less than or equal to threshold angle φ (step S13: NO), controller 60 stops harvesting operation for the current object to be harvested in step S15. In this case, for example, controller 60 may set a new object to be harvested, move harvesting device 1 to a position directly in front of the new object to be harvested, and start a new harvesting operation for the new object to be harvested again from step S1.

In step S5, by comparing the obstacle map created in step S3 with a newly created end effector map indicating the position of end effector 200, controller 60 simulates whether or not end effector 200 interferes with the obstacle when the assumed harvesting position and the appropriate position are used. The end effector map is a map created by simulating positional information of end effector 200 during movement of end effector 200 from the current position to the appropriate position in the assumed harvesting direction, and is a map indicating the end effector region illustrated in FIG. 6. Controller 60 may simulate the positional information of end effector 200 when end effector 200 is at the appropriate position based on the positional information of the object to be harvested contained in two-dimensional map 500, and simulate a position of end effector 200 while it is being moved based on the harvesting direction.

Controller 60 creates a first interference map by superimposing the obstacle map and the end effector map. The first interference map is a map indicating whether or not the obstacle and end effector 200 interfere with each other if the assumed harvesting direction and appropriate position are used. In a case where the first interference map includes a cell where a cell indicating the position of the obstacle and a cell indicating the position of the end effector (end effector region) overlap, controller 60 determines that the obstacle and end effector 200 interfere with each other if end effector 200 is moved in the assumed harvesting direction. On the other hand, in a case where the first interference map does not include a cell where a cell indicating the position of the obstacle and a cell indicating the position of the end effector (end effector region) overlap, controller 60 determines that the obstacle and end effector 200 do not interfere with each other when the assumed harvesting direction and the appropriate position are used.

Note that controller 60 may determine that the obstacle and end effector 200 do not interfere with each other in a case where a number of cells in the first interference map where a cell indicating the position of the obstacle and a cell indicating the position of end effector 200 overlap is less than or equal to a certain threshold value. This makes it possible to prevent a situation where it is determined that interference occurs even though interference does not actually occur due to erroneous recognition that may occur in recognition of obstacles or end effector 200 included in an image. This also makes it possible to perform harvesting without problem in a case where a degree of interference is small and a possibility of the interference adversely affecting the harvesting is low. As an example of the threshold value, it can be set to any value such as 3 cells, or any of a wider range of values such as from about 1 cell to about 10 cells.

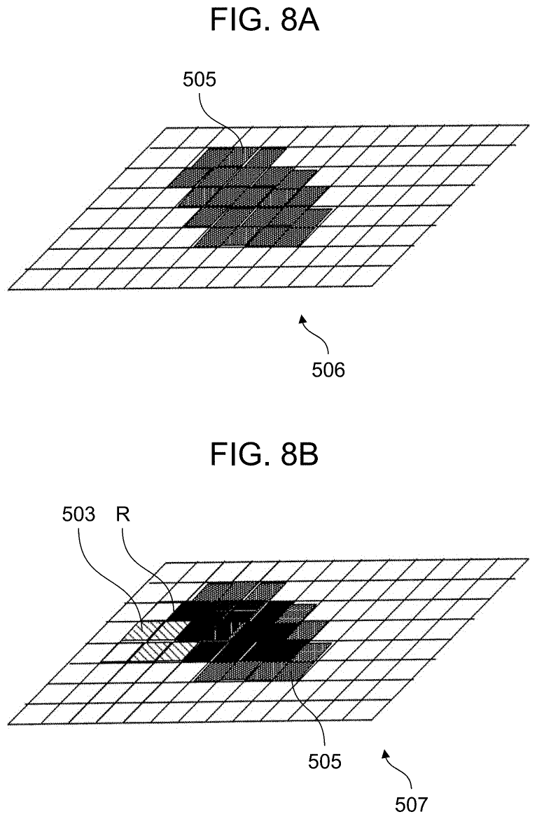

FIG. 8A illustrates end effector map 506 including end effector region 505 that indicates the position of end effector 200. In FIG. 8A, end effector region 505 corresponding to the position of end effector 200 is hatched.

FIG. 8B is a diagram illustrating first interference map 507 obtained by superimposing obstacle map 504 and end effector map 506. In first interference map 507 illustrated in FIG. 8B, obstacle region 503 indicating the position of the obstacle and end effector region 505 indicating the position of end effector 200 overlap in region R. In FIG. 8B, the overlapping region is colored black. In such a case, controller 60 determines that end effector 200 and the obstacle interfere with each other if end effector 200 is moved to the appropriate position in the assumed harvesting direction.

Returning to the description of FIG. 4, Next, in step S7, controller 60 calculates a harvesting pose of work arm 20 for moving end effector 200 along the harvesting direction determined in step S6.

[Method of Calculating Harvesting Pose of Work Arm 20]

A method of calculating the harvesting pose of work arm 20 will be described. As shown in FIG. 3, work arm 20 includes first link 21 and second link 22.

First link 21 and second link 22 are rod members. First link 21 has a first near end connected to main body 30 at point O and a first far end connected to second link 22 at point P. Second link 22 has a second near end connected to first link 21 at point P and a second far end connected to end effector 200 at point Q.

Point O is a rotation axis of first link 21 located near the first near end of first link 21 and at a center of first link 21 in a transverse direction. Point P is located near the first far end of first link 21 and at the center of first link 21 in the transverse direction. At the same time, point P is a rotation axis of second link 22 located near the second near end of second link 22 and at a center of second link 22 in the transverse direction. Point Q is located near the second far end of second link 22 and at the center of second link 22 in the transverse direction.

First link 21 can rotate with respect to main body 30 around point O as a fulcrum. Second link 22 can rotate with respect to first link 21 around point P as a fulcrum. End effector 200 can rotate with respect to second link 22 around point Q as a fulcrum. These structures allow work arm 20 to take various poses and move the position of end effector 200 to various positions with respect to main body 30.

In the present exemplary embodiment, the harvesting pose of work arm 20 refers to positions of first link 21 and second link 22 when end effector 200 is moved to the appropriate position for harvesting. A specific example of the harvesting pose of work arm 20 is positions of point O, point P, and point Q when end effector 200 is at the appropriate position.

Controller 60 determines the harvesting pose of work arm 20 based on the appropriate position of end effector 200 as viewed from harvesting device 1, the harvesting direction determined in step S6 (the moving direction of end effector 200), and link lengths of first link 21 and second link 22. Controller 60 calculates the positional information of end effector 200 when end effector 200 is at the appropriate position based on the positional information of the object to be harvested included in two-dimensional map 500. Further, controller 60 calculates the positions of point O, point P, and point Q when end effector 200 is at the appropriate position using inverse kinematics, and the calculated positions or a calculated angle(s) are used as the harvesting pose of work arm 20. Instead of the positions of point O, point P, and point Q, an angle formed by a straight line connecting point O and point P and a straight line connecting point P and point Q may be used as the harvesting pose of work arm 20.

Returning to the description of FIG. 4, Next, in step S8, controller 60 creates a harvesting pose map corresponding to the harvesting pose of work arm 20 calculated in step S7.

[Method of Creating Harvesting Pose Map]

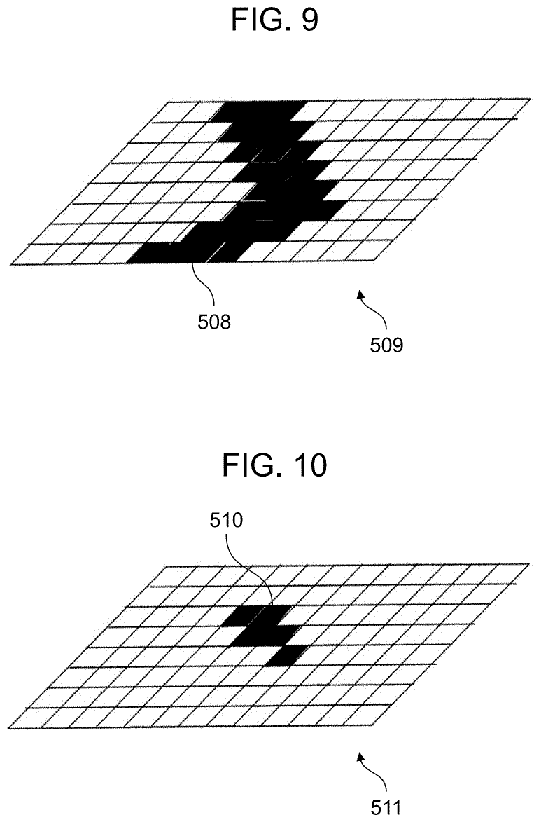

A creating method similar to that of the above-described method of creating an obstacle map may be adopted as the method of creating a harvesting pose map. That is, based on the harvesting pose of work arm 20 (that is, the positions of point O, point P, and point Q of work arm 20 when end effector 200 is at the appropriate position) calculated in step S7, in two-dimensional map 500 illustrated in FIG. 5A, a value of “1” is given to a cell where work arm 20 is found, and a value of “0” is given to a cell where work arm 20 is not found. FIG. 9 is a diagram illustrating harvesting pose map 509. As a result, as illustrated in FIG. 9, harvesting pose map 509 including work arm region 508 composed of a plurality of cells (a group of cells having a value of “1”) including part of work arm 20 is created.

Returning to the description of FIG. 4, Next, in step S9, controller 60 creates a second interference map for simulating whether or not work arm 20 and the obstacle interfere with each other when end effector 200 is positioned at the appropriate position.

The second interference map is created by superimposing the obstacle map created in step S3 and the harvesting pose map created in step S8, and extracting cells where obstacle region 503 indicating the position of the obstacle and work arm region 508 indicating the position of work arm 20 overlap. That is, the second interference map is a map indicating whether or not an obstacle interferes with work arm 20 when end effector 200 is moved to the appropriate position. FIG. 10 is a diagram illustrating second interference map 511. In FIG. 10, cells where cells indicating the position of the obstacle (obstacle region 503) and cells indicating the position of work arm 20 (work arm region 508) overlap are colored black (interference region 510). Presence of interference region 510 in created second interference map 511 means that work arm 20 and the obstacle interfere with each other when end effector 200 is positioned at the appropriate position.

Note that controller 60 may determine that the obstacle and work arm 20 do not interfere with each other in a case where a number of cells in the second interference map where a cell indicating the position of the obstacle and a cell indicating the position of work arm 20 overlap is less than or equal to a certain threshold value. This makes it possible to prevent a situation where it is determined that interference occurs even though interference does not actually occur due to erroneous recognition that may occur in recognition of obstacles or work arm 20 included in the image. This also makes it possible to perform harvesting without problem in a case where a degree of interference is small and a possibility of the interference adversely affecting the harvesting is low. As an example of the threshold value, it can be set to any value such as 3 cells, or any of a wider range of values such as from about 1 cell to about 10 cells.

Returning to the description of FIG. 4, next, in step S10, controller 60 determines whether or not work arm 20 and the obstacle interfere with each other when end effector 200 is positioned at the appropriate position based on the second interference map created in step S9. As described above, a decision is made in step S10 by detecting whether there is interference region 510 in second interference map 511.

When it is determined that interference occurs (step S10: YES), controller 60 advances the processing to step S15. When it is determined that interference does not occur (step S10: NO), controller 60 advances the processing to step S11.

In the case where it is determined that interference occurs, in step S15, controller 60 determines that the harvesting operation should not be performed for the object to be harvested targeted in a current flow.

Next, in step S11, controller 60 determines that the harvesting operation should be performed for the object to be harvested targeted in the current flow, and controls the harvesting device. Specifically, end effector 200 is moved in accordance with the harvesting direction determined in step S6. This makes it possible to avoid obstacles while end effector 200 is being moved to the appropriate position for harvesting.

In step S12, controller 60 controls end effector 200 to harvest the object to be harvested.

[Harvesting Method Using End Effector 200]

A method using end effector 200 to harvest the object to be harvested will be described below.

FIG. 11 is a perspective view of end effector 200. As illustrated in FIG. 11, end effector 200 includes pull-back guide 201, harvest ring 202, harvest fruit guide 203, harvest fruit seat 204, and base 205. Harvest ring 202 is configured to be separable into two parts, namely, upper and lower parts. Under control of controller 60, the upper part of harvest ring 202 can move relative to the lower part. In the following description, as illustrated in FIG. 11, a vertical direction of the object to be harvested and end effector 200 is defined by assuming that a side of pull-back guide 201 of end effector 200 is up and a base 205 side is down.

In many cases, the cherry tomatoes as the objects to be harvested in the present exemplary embodiment are harvested by picking pieces of fruit attached to a cluster one by one instead of harvesting them together as a cluster. This is because, since maturity of the pieces of fruit attached to a cluster is different for each piece, it is preferable to harvest only pieces of fruit that are sufficiently matured. In addition, since cherry tomatoes are generally to be eaten raw, it is necessary to harvest them with the calyces without damaging a surface of the fruit.

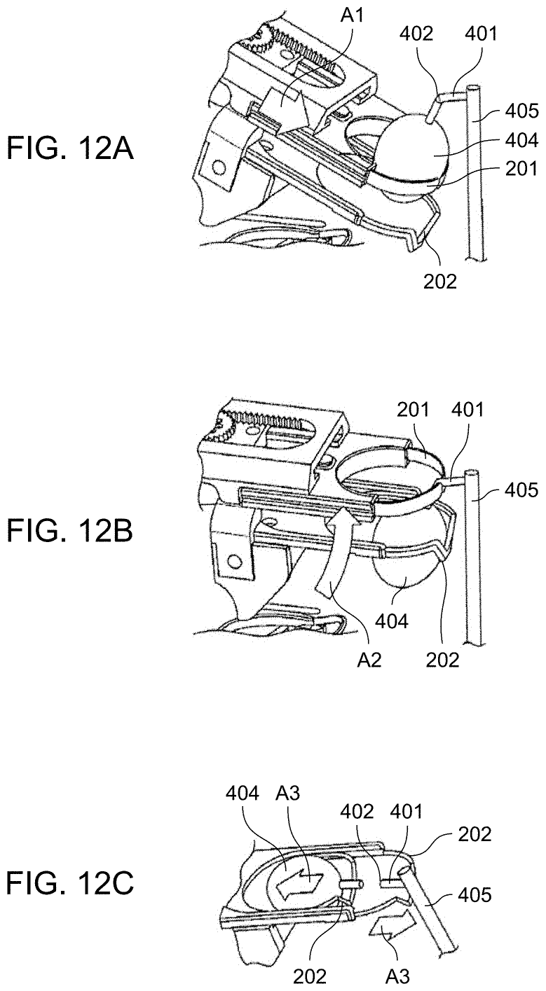

FIGS. 12A to 12C are diagrams illustrating operation of end effector 200 during harvesting. FIG. 12A illustrates an operation of pulling back fruit 404 as the object to be harvested. FIG. 12B illustrates an insertion operation of harvest ring 202. FIG. 12C illustrates separation of fruit 404 and an operation of harvesting it.

As illustrated in FIG. 12A, first, pull-back guide 201 including a band member that generally has the shape of an arc is moved toward the fruit 404 side of the object to be harvested (arrow A1 in FIG. 12A) so that fruit 404 enters a space inside pull-back guide 201 through a cut provided in pull-back guide 201. In this state, fruit 404 is pulled back from below using pull-back guide 201 to create a gap between it and other cherry tomatoes (not illustrated).

Next, as illustrated in FIG. 12B, harvest ring 202 is inserted into the gap by moving entire end effector 200 upward (arrow A2 in FIG. 12B). At this time, pedicel 401 passes through the cut in pull-back guide 201, and fruit 404 exits the space inside pull-back guide 201.

After that, as shown in FIG. 12C, the upper part of harvest ring 202 is moved relative to the lower part thereof (arrow A3 in FIG. 12C) to pull fruit 404 and push away peduncle 405. This causes pedicel 401 to stretch and tear at abscission layer 402. As a result, fruit 404 whose pedicel 401 is torn at abscission layer 402 and having no (little) damage can be harvested.

After that, harvested fruit 404 passes through harvest fruit guide 203 and harvest fruit seat 204 to be stored in a harvest container (not illustrated) or the like provided in the lower part. This completes the harvest operation in step S12.

Once the object to be harvested is harvested in step S12, controller 60 controls main body moving unit 10 to move main body 30 to a position directly in front of a new object to be harvested, and starts the harvesting operation of harvesting device 1 again from step S1. By repeating this, a plurality of objects to be harvested can be suitably harvested.

As described above, according to harvesting device 1 of the exemplary embodiment of the present disclosure, when end effector 200 for automatically harvesting the object to be harvested is moved to the appropriate position, the position of work arm 20 or main body 30 is moved such that end effector 200 or work arm 20 does not interfere with an obstacle. This makes it possible to efficiently perform stable automatic harvesting.

<Modification>

In the above-described exemplary embodiment, end effector 200 and work arm 20 have been exemplified and described as examples of the harvesting unit and the harvesting unit-moving unit of the present disclosure, respectively. However, the harvesting unit of the present disclosure may have a structure completely different from that of end effector 200 illustrated in figures such as FIG. 11, and any harvesting unit can be used as long as it has a structure that makes it possible to harvest the object to be harvested at the abscission layer without damaging it. Further, the harvesting unit-moving unit of the present disclosure may have a structure completely different from that of work arm 20 illustrated in figures such as FIG. 3, and any harvesting unit-moving unit can be used as long as it has a structure that makes it possible to move the harvesting unit freely moved, such as a wire that can be bent at any position.

In the above-described exemplary embodiment, in steps S7 to S10, controller 60 determines whether the work arm interferes with an obstacle if end effector 200 is positioned at the appropriate position. In addition, controller 60 may determine whether work arm 20 interferes with an obstacle while end effector 200 is moving from a home position to the appropriate position. For example, controller 60 may generate a first pose map based on a pose of work arm 20 at a first timing during the movement of end effector 200, and generate a second pose map based on a pose of work arm 20 at a second timing different from the first timing during the movement of end effector 200. Controller 60 may determine whether work arm 20 interferes with the obstacle at the first timing based on the first pose map and the obstacle map, and determine whether work arm 20 interferes with the obstacle at the second timing based on the second pose map and the obstacle map. Controller 60 may calculate a moving direction and an amount of movement of the harvesting device when it is determined that work arm 20 interferes with the obstacle at one of the first timing and the second timing.

According to the present invention, the stability of harvesting can be enhanced.

The harvesting device of the present disclosure is useful for automatically harvesting an object to be harvested, such as a fruit.

What is claimed is:

1. A harvesting device comprising:
a harvesting unit that harvests an object to be harvested;
a harvesting unit-moving unit that moves the harvesting unit to an appropriate position for harvesting the object to be harvested;
an imaging unit that captures an image; and
a controller,
wherein the controller performs
a first step of determining, based on the image, whether or not interference between the harvesting unit and an obstacle occurs when the harvesting unit is positioned at the appropriate position,
a second step of determining, based on the image, whether or not interference between the harvesting unit-moving unit and the obstacle occurs when the harvesting unit is positioned at the appropriate position, when it is determined in the first step that the interference does not occur, and
a third step of causing the harvesting unit to harvest the object to be harvested when it is determined in the second step that the interference does not occur.

2. The harvesting device according to claim 1, wherein the controller determines the appropriate position of the harvesting unit based on a position of the object to be harvested calculated from the image.

3. The harvesting device according to claim 1, wherein, in the first step, the controller generates first coordinate data indicating a region occupied by the harvesting unit in a space and second coordinate data indicating a region occupied by the obstacle in the space.

4. The harvesting device according to claim 3, wherein
the first coordinate data and the second coordinate data are each a grid map including a plurality of cells, and
in the first step, the controller determines whether the interference occurs based on a number of cells that overlap when the first coordinate data and the second coordinate data are superimposed.

5. The harvesting device according to claim 1, wherein, when the controller determines that the interference occurs in the first step, the controller changes an angle of the harvesting unit with respect to the object to be harvested and executes the first step again.

6. The harvesting device according to claim 1, wherein, in the second step, the controller generates third coordinate data indicating a region occupied by the harvesting unit-moving unit in a space and fourth coordinate data indicating a region occupied by the obstacle in the space.

7. The harvesting device according to claim 6, wherein
the third coordinate data and the fourth coordinate data are each a grid map including a plurality of cells, and
in the second step, the controller determines whether the interference occurs based on a number of cells that overlap when the third coordinate data and the fourth coordinate data are superimposed.

8. A harvesting method performed by a computer that controls a harvesting device, the method comprising:
a first step of determining, based on a captured image, whether or not interference between a harvesting unit that harvests an object to be harvested and an obstacle occurs when the harvesting unit is positioned at an appropriate position for harvesting the object to be harvested;
a second step of determining, based on the captured image, whether or not interference between a harvesting unit-moving unit that moves the harvesting unit to the appropriate position and the obstacle occurs when the harvesting unit is positioned at the appropriate position, when it is determined in the first step that the interference does not occur; and
a third step of causing the harvesting unit to harvest the object to be harvested when it is determined in the second step that the interference does not occur.

9. A recording medium recording a program executed by a computer that controls a harvesting device, the program causing the computer to perform:
a first procedure of determining, based on a captured image, whether or not interference between a harvesting unit that harvests an object to be harvested and an obstacle occurs when the harvesting unit is positioned at an appropriate position for harvesting the object to be harvested;
a second procedure of determining, based on the captured image, whether or not interference between a harvesting unit-moving unit that moves the harvesting unit to the appropriate position and the obstacle occurs when the harvesting unit is positioned at the appropriate position, when it is determined in the first procedure that the interference does not occur; and
a third procedure of causing the harvesting unit to harvest the object to be harvested when it is determined in the second procedure that the interference does not occur.
